(19) United States
(12) Patent Application Publication
(10) Pub. No.: US 2009/0294473 A1
(43) Pub. Date: Dec. 3, 2009

(54) Canned beverage tapper

(76) Inventor: Steven J. Frey, Dearborn Heights, MI (US)

Correspondence Address: Steven J. Frey, 3955 Mayfair Street, Dearborn Heights, MI, 48125-3039, US

(21) Appl. No.: 12/156,546

(22) Filed: Jun. 3, 2008

(51) Int. Cl. B67D 5/00; B67B 7/48

(52) U.S. Cl. 222/88; 81/3.48

(57) ABSTRACT

A canned beverage opener that is both functional and enjoyable to use. A rotating carousel containing several unopened beverage cans and ice is mounted to a base, with an inclined top. A drinking vessel is placed inside the base. When a consumer pulls on a handle, the canned beverage is opened by depressing the can's pop top, and the contents of the can are emptied into the vessel, thus simulating the tapping of a keg. Vent holes may be created in the cans by depressing a sharp tipped plunger mounted to the cover of the carousel. To open additional cans, the entire carousel may be rotated about a central shaft. Once all of the cans are empty, the consumer may remove the cover and replace the empty cans with unopened cans, and refill the ice if necessary.

### RELATED APPLICATIONS

The present application is a continuation-in-part application of U.S. provisional patent application Ser. No. 60/932,512, filed May 31, 2007, for BEVERAGE CAN TAPPER, by Steven Joseph Frey, included by reference herein and for which benefit of the priority date is hereby claimed.

### FIELD OF THE INVENTION

The present invention relates to a beverage dispenser and, more particularly, to simulating the tapping and dispensing of beverages from draft beer kegs.

### BACKGROUND OF THE INVENTION

Most people are familiar with beverages packaged in cans, e.g., beer, soda, juice. At the same time most people do not like to drink directly from a can, and would rather pour their favorite beverage into a cup, mug or glass.

Another way to package beer is to utilize a keg. A party or gathering with a keg is commonly referred to as a “kegger”, and the very existance of the keg adds to the overall enjoyment of the party. Unfortunately, these kegs require large amounts of refrigeration and are not easily portable. Although the use of a keg is very popular with consumers at parties, the large quantity of beverage contained within the keg causes most consumers to avoid this option for casual use.

It is therefore an object of the invention to provide an enjoyable means for dispensing beverages from cans.

It is another object of the invention to provide a portable means to simulate the tapping of a beer keg.

### SUMMARY OF THE INVENTION

In accordance with the present invention, there is provided a canned beverage opener that is both functional and enjoyable to use. A rotating carousel containing several unopened beverage cans and ice is mounted to a base, with an inclined top. A drinking vessel is placed inside the base. When a consumer pulls on a handle, the canned beverage is opened by depressing the can's pop top, and the contents of the can are emptied into the vessel, thus simulating the tapping of a keg. Vent holes may be created in the cans by depressing a sharp tipped plunger mounted to the cover of the carousel. To open additional cans, the entire carousel may be rotated about a central shaft. Once all of the cans are empty, the consumer may remove the cover and replace the empty cans with unopened cans, and refill the ice if necessary.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of the canned beverage tapper in accordance with the invention;

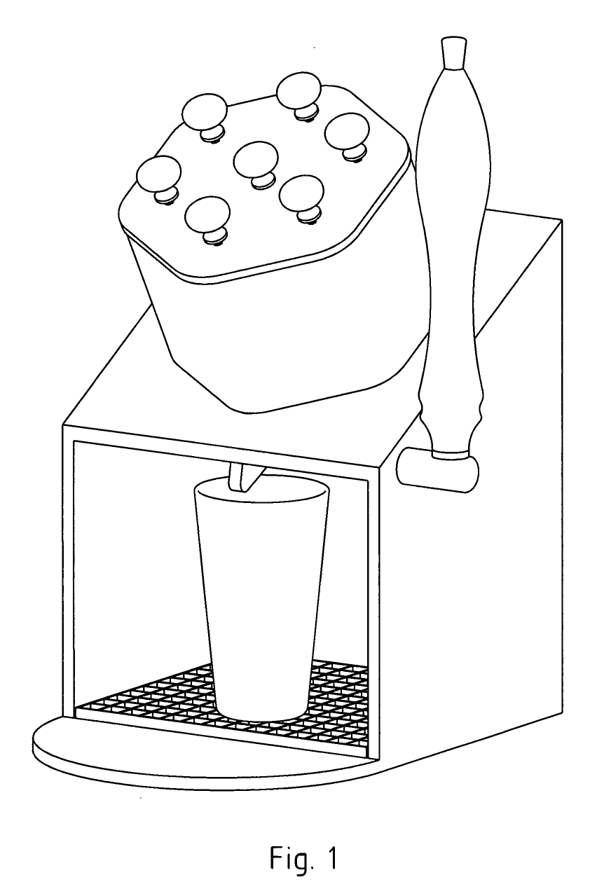

FIG. 2 is an exploded perspective view of the invention;

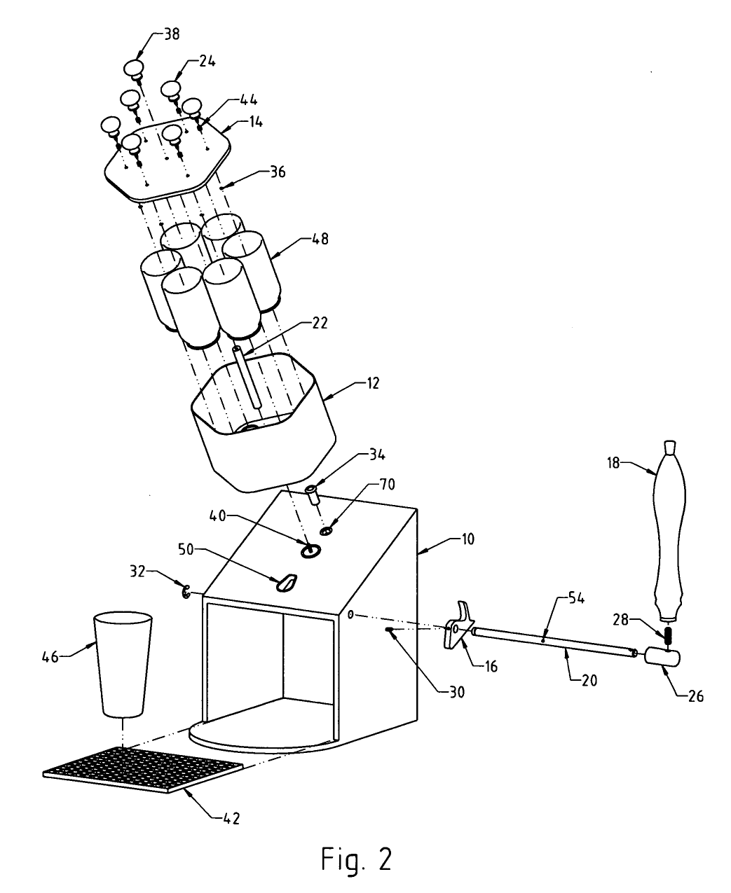

FIG. 3 is a front elevation view of the invention;

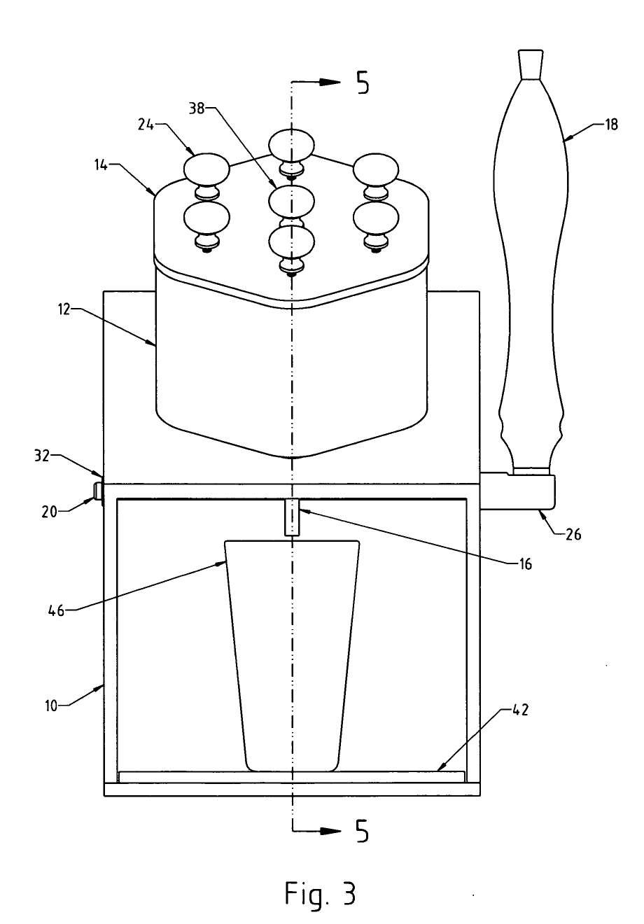

FIG. 4 is a right elevation view of the invention;

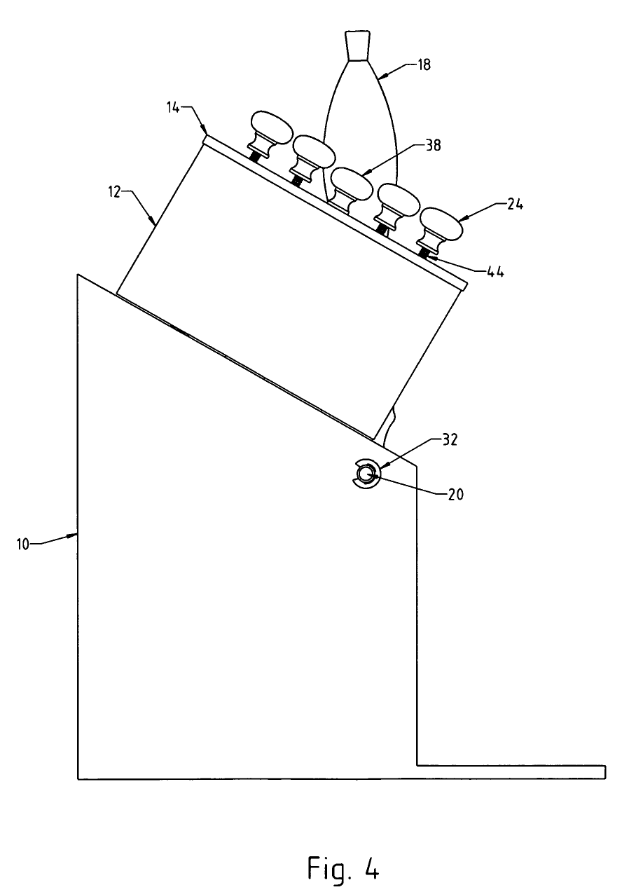

FIG. 5 is a right section view of the invention as indicated in FIG. 3, showing the invention in the disengaged, or at rest, position;

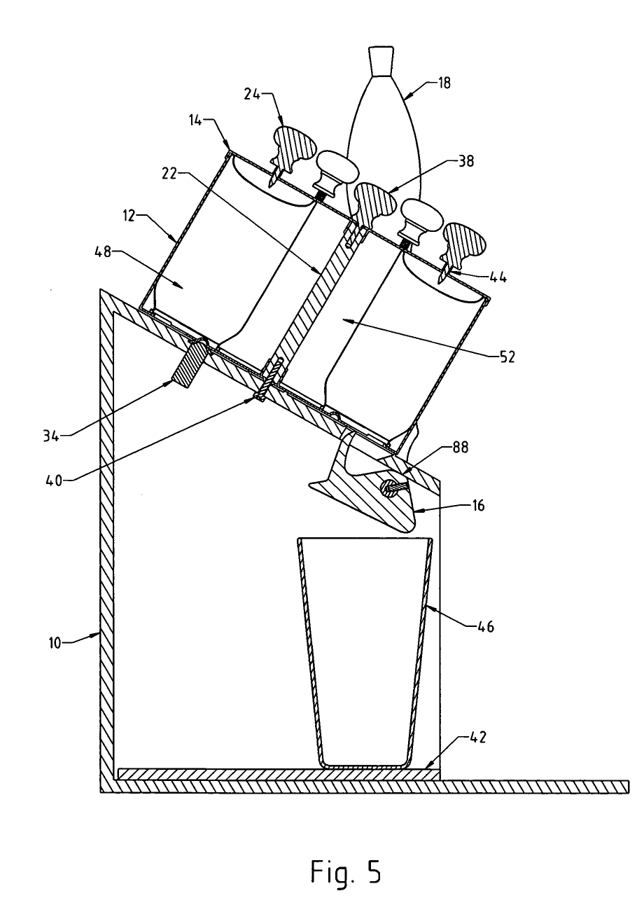

FIG. 6 is a right section view of the invention as indicated in FIG. 3, showing the invention in the engaged, or active position;

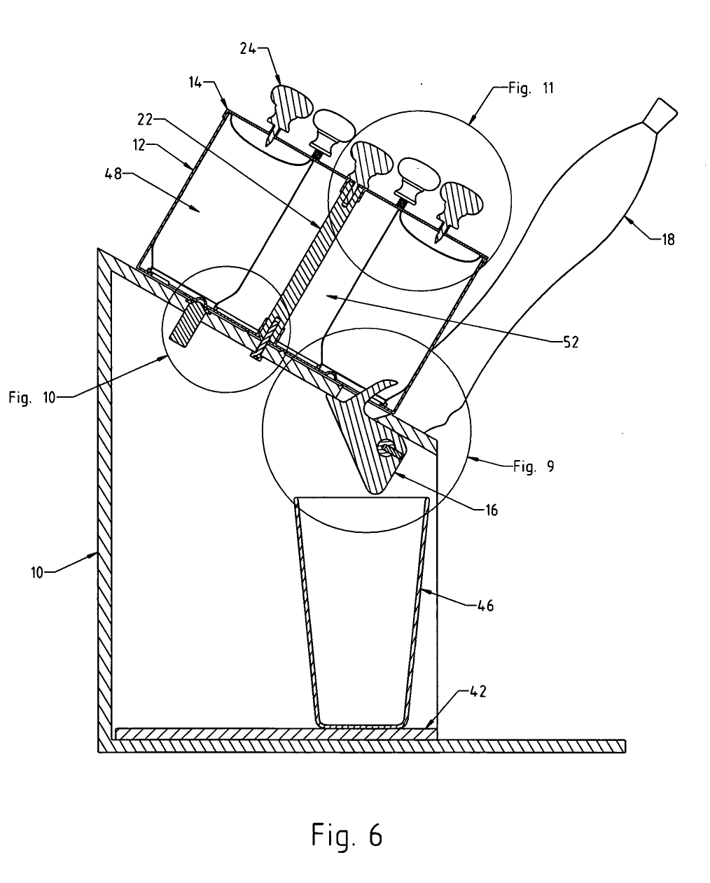

FIG. 7 is a left elevation view of the invention;

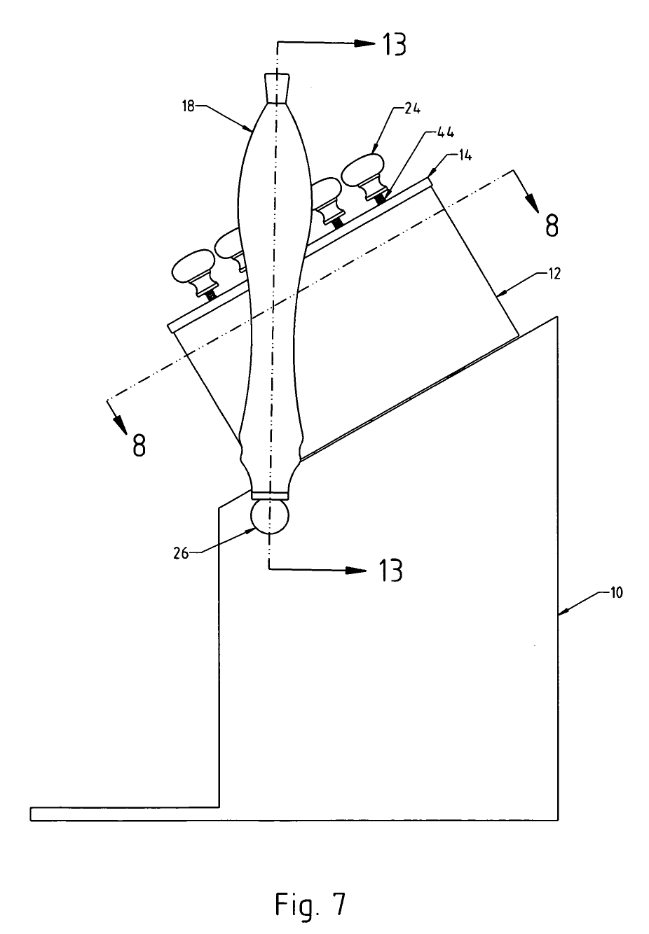

FIG. 8 is an auxiliary section view of a view of the invention, as indicated in FIG. 7;

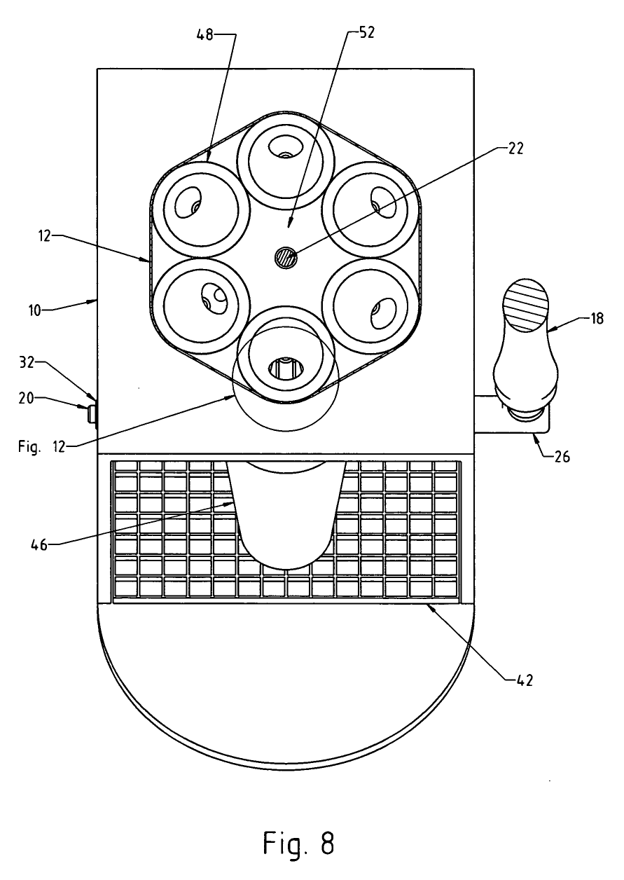

FIG. 9 is a detailed sectional view of the invention, as indicated in FIG. 6;

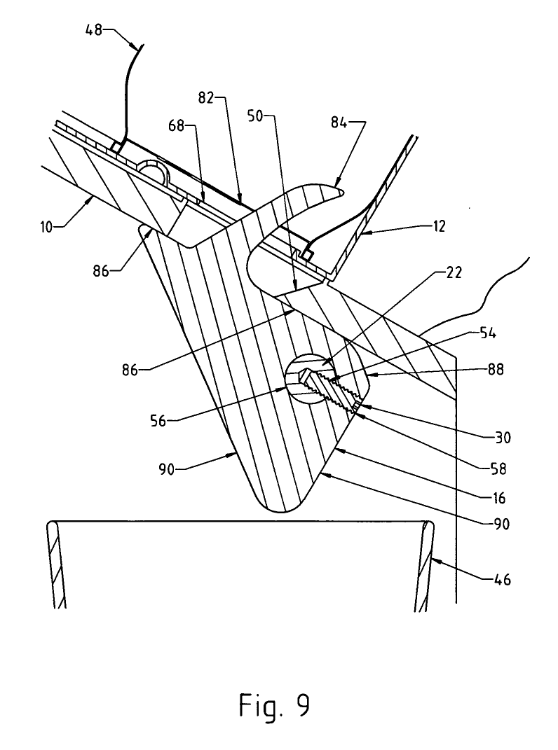

FIG. 10 is a detailed sectional view of the invention, as indicated in FIG. 6;

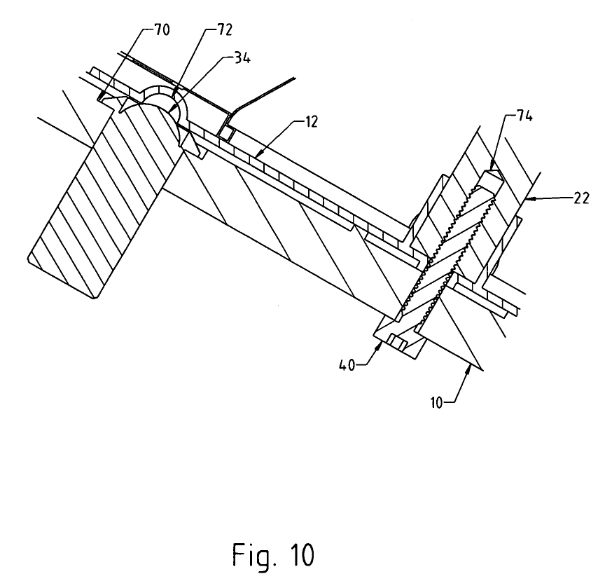

FIG. 11 is a detailed sectional view of the invention, as indicated in FIG. 6;

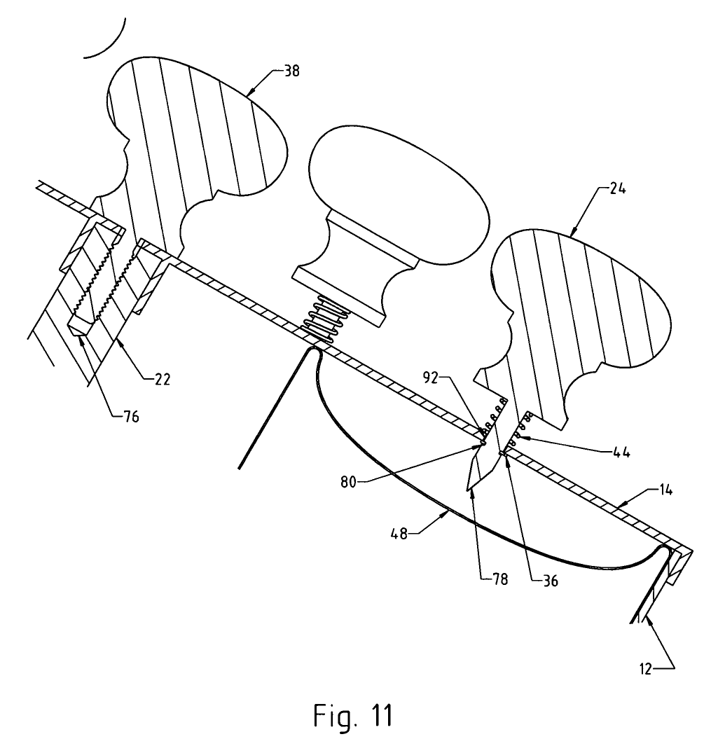

FIG. 12 is a detailed sectional view of the invention, as indicated in FIG. 8;

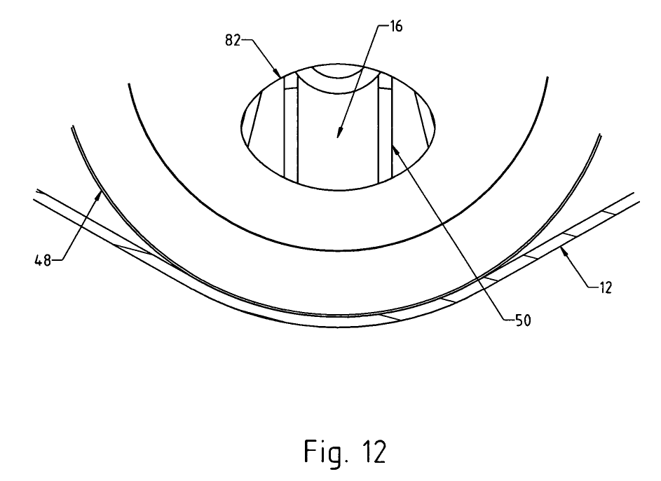

FIG. 13 is an auxiliary section view of the invention as indicated in FIG. 7;

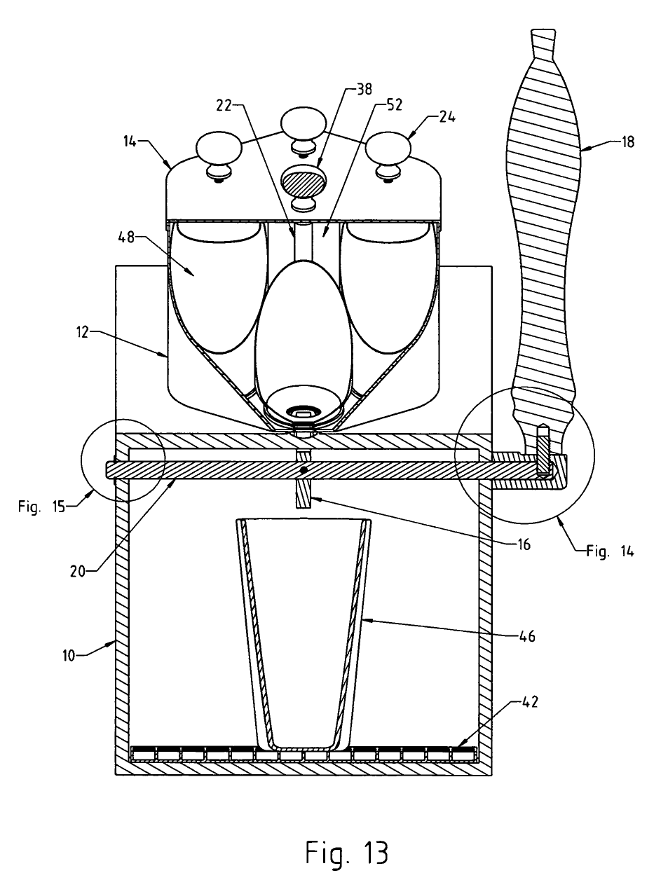

FIG. 14 is a detailed sectional view of the invention as indicated in FIG. 13;

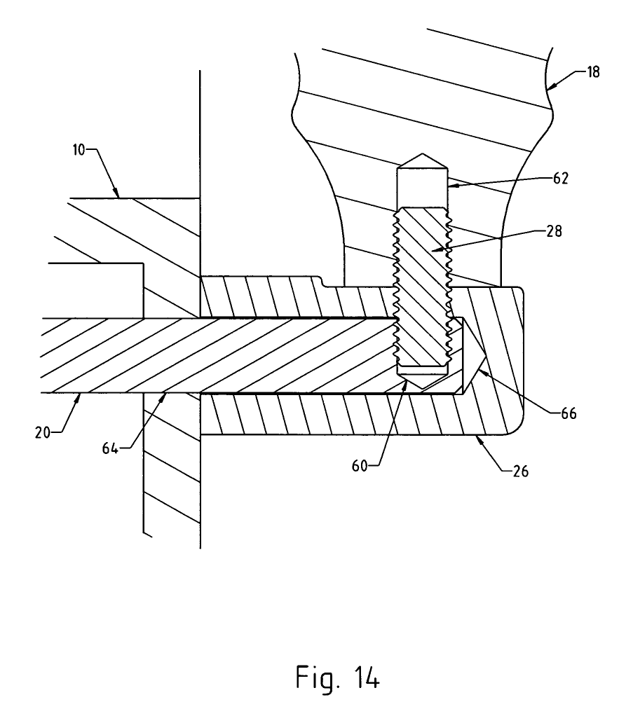

FIG. 15 is a detailed sectional view of the invention as indicated in FIG. 13;

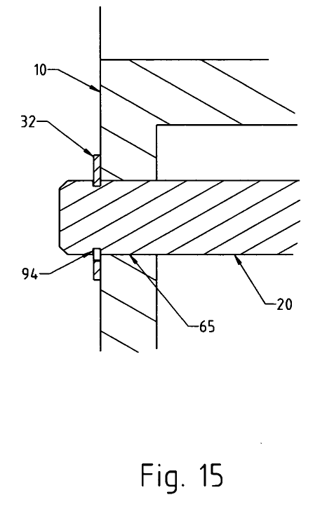

FIG. 16 is a perspective view of an opener 16;

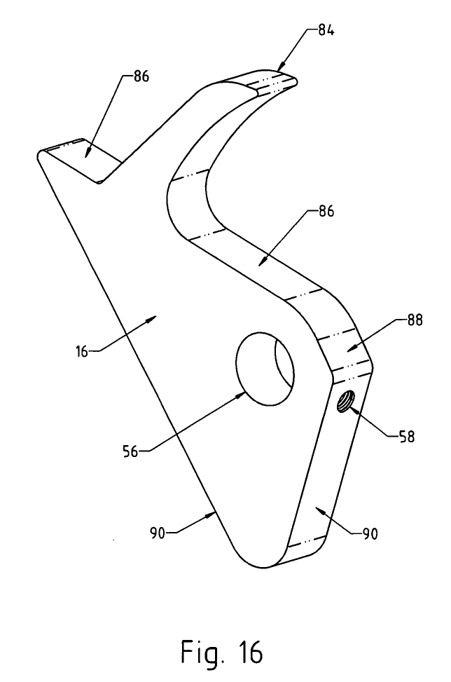

FIG. 17 is a perspective view of a base 10; and

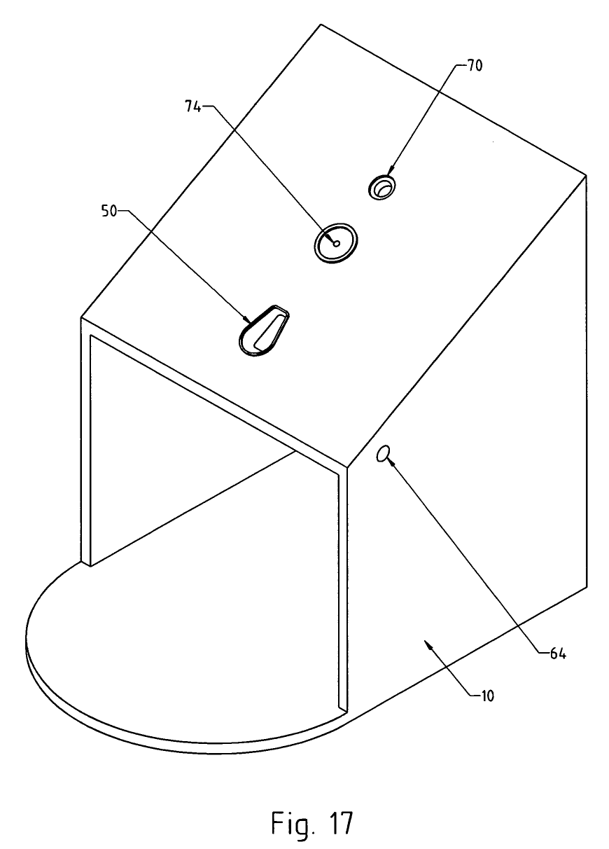

FIG. 18 is a bottom perspective view of a carousel 12.

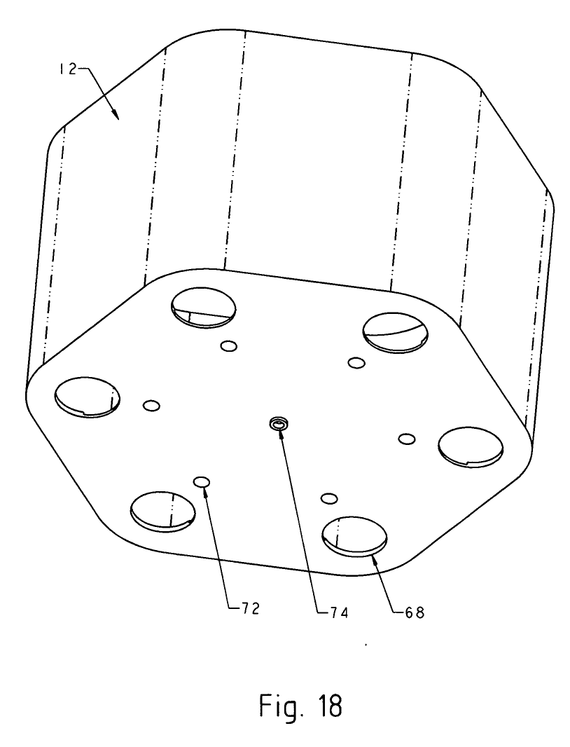

For purposes of clarity and brevity, like elements and components will bear the same designations and numbering throughout the Figures.

### DESCRIPTION OF THE PREFERRED EMBODIMENT

The pivot shaft 20 is axially mounted to the base 10 through the pivot shaft mount hole 64 and retained to base 10 with shaft clip 32 fastened to shaft clip slot 94. The opener 16 is mounted to the pivot shaft 20 through the opener mounting hole 56 and held securely in place by the set screw 30 threaded into the anti-rotation hole 58 in the opener 16 and the opener retaining hole 54 in the pivot shaft 20. The pivot shaft 20 is further retained in the base 10 by the hub 26 which is mounted to the pivot shaft 20 through the hub mount hole 66, and held in place by the handle stud 28 threaded into the hub retaining hole 60 in the hub 26 and pivot shaft 20. The handle 18 is threaded onto the handle stud 28 through the handle mount hole 62. The spring stop 34, available from McMaster-Carr, 200 Aurora Industrial Parkway, Aurora, Ohio 44202-8087, is mounted to the base 10 through the spring stop mount hole 70.

A plurality of beverage can 48 are inverted and placed hexagonally in the carousel 12. The carousel 12 is positioned on top of the inclined surface of the base 10, and axially on the spin shaft 22. The spin shaft 22 is secured to the base 10 by means of the shaft screw 40 threaded into the spin shaft mount hole 74 in the base 10 and bottom of the spin shaft 22. The plurality of beverage can 48 are vertically secured within the carousel 12 by the lid 14 which is place on top of the carousel 12, and held in place by the retaining knob 38, threaded into the lid mount hole 76 in the lid 14 and top of the spin shaft 22. A plurarity of plunger 24 are mounted to the lid 14 with the punch 78 passing through plunger hole 92 and compression spring 44 and retained by plunger clip 36 fastened to plunger clip slot 80.

The carousel 12 is positioned so that the spring stop 34 engages the dimple 72, insuring proper alignment. To dispense beverages, the consumer pulls on the handle 18, which rotates the hub 26, pivot shaft 20 and opener 16 until the engagement stop 86 contacts the base 10. Simultaneously, the tooth 84 on the opener 16 passes freely through the base opening 50 and carousel opening 68 and presses on the pop top opening 82 forcing the pop top opening 82 to unseal, and release the contents of the beverage can 48. Gravity causes the contents of the beverage can 48 to flow through the carousel opening 68 and base opening 50 and along the flow director 90 features on the opener 16 and into the drinking vessel 46 resting on top of the optional drip tray 42 inside the base 10. To increase flow of the beverage into the drinking vessel 46, a vent hole may be created in beverage can 48 by depressing the plunger 24, forcing the punch 78 into the can. When the plunger 24 is released, the compression spring 44 automatically retracts the punch 78 from the vent hole.

To open additional beverage can 48, the handle 18 is pushed, which rotates the hub 26, pivot shaft 20 and opener 16 until the disengagement stop 88 contacts the base 10. Simultaneously, the tooth 84 on the opener 16 retracts from the pop top opening 82, carousel opening 68 and base opening 50. The carousel 12 is rotated so that the pop top opening 82 on the next unopened beverage can 48 is positioned over the base opening 50, and the spring stop 34 engages the dimple 72.

Optionally, the ice chamber 52 may be filled with ice to provide cooling of the beverages contained within the beverage can 48.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A canned beverage tapper for opening and dispensing beverages, comprising:
means for providing an elevated surface to hold a beverage can opening device above a drinking vessel;
means for holding and retaining a plurality of beverage cans and ice;
means for vertically retaining a plurality of beverage cans;
means for opening beverage cans and directing the flow of contents;
means for providing a user interface to open beverage cans;
means for puncturing beverage cans for providing air venting; and
means for holding beverage and preserving carbonation until ready to consume.

2. The canned beverage tapper in accordance with claim 1, wherein said means for providing an elevated surface to hold a beverage can opening device above a drinking vessel comprises an inclined upper surface, open front base.

3. The canned beverage tapper in accordance with claim 1, wherein said means for holding and retaining a plurality of beverage cans and ice comprises a significantly hexagonal, flat bottom, open top carousel.

4. The canned beverage tapper in accordance with claim 1, wherein said means for vertically retaining a plurality of beverage cans comprises a flat, perimeter lipped lid.

5. The canned beverage tapper in accordance with claim 1, wherein said means for opening beverage cans and directing the flow of contents comprises a multi-sided, tooth-like opener.

6. The canned beverage tapper in accordance with claim 1, wherein said means for providing a user interface to open beverage cans comprises a cylindrical, tapered, rectangular or spindle shaped handle.

7. The canned beverage tapper in accordance with claim 1, wherein said means for puncturing beverage cans for providing air venting comprises a sharp-tipped plunger.

8. The canned beverage tapper in accordance with claim 1, wherein said means for holding beverage and preserving carbonation until ready to consume comprises a commercially packaged, sealed beverage can.
